(19) United States
(12) Patent Application Publication
(10) Pub. No.: US 2022/0301178 A1
(43) Pub. Date: Sep. 22, 2022

(54) IMAGE ADJUSTING METHOD AND APPLICATIONS THEREOF

(71) Applicant: BENQ CORPORATION, Taipei (TW)

(72) Inventors: Chia-Nan SHIH, Taipei (TW); Chih-Pen HUANG, Taipei (TW); Chang-Sheng LEE, Taipei (TW)

(73) Assignee: BENQ CORPORATION, Taipei (TW)

(21) Appl. No.: 17/691,173

(22) Filed: Mar. 10, 2022

(30) Foreign Application Priority Data
Mar. 18, 2021 (CN) 202110292341.0

(51) Int. Cl. G06T 7/12; G06T 3/00; G06F 3/04845; G06T 3/40

(52) U.S. Cl. CPC G06T 7/12; G06T 3/0093; G06F 3/04845; G06T 3/403

(57) ABSTRACT

An image adjusting method including the following steps is provided. Firstly, the original image is divided into a plurality of image areas by a plurality of mutually intersecting virtual lines, wherein the image areas include a plurality of edge areas, each being defined by at least one original image edge of the original image and at least two of the virtual lines. Then, the coordinate of at least one intersection of at least one of the virtual lines and the original image edge are changed to obtain a deformed image edge. Subsequently, at least one original pixel located in one of the edge regions in the original image is repositioned according to the at least two of the virtual lines and the deformed image edge.

This application claims the benefit of People's Republic of China application Serial No. 202110292341.0, filed Mar. 18, 2021, the subject matter of which is incorporated herein by reference.

### BACKGROUND OF THE INVENTION

### Field of the Invention

The invention relates in general to a multi-media data processing method, and applications system thereof, and more particularly to an image adjusting method and applications system thereof.

### Description of the Related Art

Along with the advance in the technology of virtual reality, different display devices are used to display 3D images of virtual reality. For example, the display with curved screen is used to implement high-resolution immersive visualization environment. When processing the input signal of a conventional 2D image, the original image data received by the display may not fill up the screen and the image may be displayed delay or distortion. Thus, the deformation of the image needs to be adjusted.

Another application of virtual reality is wrap-around immersive virtual reality implemented by a projector projecting the image in a simulation cockpit or on irregular surface in the ambient environment. When performing non-linear projection on a screen with arbitrary curve, the image must be corrected in advance otherwise image distortion will occur.

Therefore, it has become a prominent task for the industries to provide an advanced image adjusting method and applications thereof for resolving the problems encountered in the prior art.

### SUMMARY OF THE INVENTION

According to one embodiment of the present disclosure, an image adjusting method including the following steps is provided. Firstly, the original image is divided into a plurality of image areas by a plurality of mutually intersecting virtual lines, wherein the image areas include a plurality of edge areas, each being defined by at least one original image edge of the original image and at least two of the virtual lines. Then, a coordinate of at least one intersection of at least one of the virtual lines and the at least one original image edge is changed to obtain a deformed image edge. Subsequently, at least one original pixel located in one of the edge regions in the original image is repositioned according to the at least two of the virtual lines and the deformed image edge.

According to another embodiment of the present disclosure, image adjustment system using a user interface (UI) to execute the above image adjustment method is provided.

According to another embodiment of the present disclosure, a projector image adjusting system is provided. The projector image adjusting system includes a projection device and a user interface. The user interface is configured to provide a plurality of mutually intersecting virtual lines for dividing the image into a plurality of image areas, wherein the image areas include a plurality of edge areas, each being defined by at least one original image edge of the original image and at least two of the virtual lines; to change a coordinate of at least one intersection of at least one of the virtual lines and the at least one original image edge to obtain a deformed image edge; and to reposition at least one original pixel located in one of the edge regions in the original image according to at least two of the virtual lines and the deformed image edge to convert the original image into an adjusted image. The projection device is configured to project the original image and the adjusted image.

As disclosed above, the embodiments of the present disclosure provide an image adjusting method and applications thereof. An original image is divided into a plurality of image areas by a plurality of virtual lines to provide the user with a number of selection points which are define by the virtual lines intersecting with the original image edge of the original image. The user can change the coordinate of the selected point to obtain a deformed image edge by using a specific algorithm (such as interpolation). Then, at least one original pixel located in the edge area of the original image can be repositioned according to the deformed image edge for converting the original image into an adjusted image. In other words, by changing the displaying position of the selected point at the image edge of the original image through a user interface, the user can easily adjust the shape of the original image to generate an adjusted image (deformed image) meeting the requirements.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a flowchart of an image adjusting method according to an embodiment of the present disclosure;

FIG. 2 is a block diagram of a projector image adjusting system applicable of implementing the image adjusting method according to an embodiment of the present disclosure;

FIG. 3A is a schematic frame of an original image according to an embodiment of the present disclosure;

FIG. 3B to FIG. 3C are schematic frames of image adjustment of the original image of FIG. 3A according to an embodiment of the present disclosure;

FIG. 4A to and FIG. 4B are schematic diagrams of a part of curve conversion step of converting a deformed polyline into a deformed image edge with a continuous and smooth shape according to an embodiment of the present disclosure;

FIG. 5A is a schematic frame of an original image according to another embodiment of the present disclosure;

FIG. 5B to FIG. 5C are schematic frames of image adjustment of the original image of FIG. 5A according to another embodiment of the present disclosure;

FIG. 6A and FIG. 6B are schematic frames of proportionally scaling the original image according to an alternate embodiment of the present disclosure.

### DETAILED DESCRIPTION OF THE INVENTION

The present disclosure provides an image adjusting method and applications thereof capable of generating an adjusted image meeting the requirements by adjusting the shape of the original image through simple operations. For the object, technical features and advantages of the present disclosure to be more easily understood by anyone ordinary skilled in the technology field, a number of exemplary embodiments are disclosed below with detailed descriptions and accompanying drawings.

It should be noted that these embodiments are for exemplary and explanatory purposes only, not for limiting the scope of protection of the invention. The invention can be implemented by using other features, elements, methods and parameters. The preferred embodiments are merely for illustrating the technical features of the invention, not for limiting the scope of protection. Anyone skilled in the technology field of the invention will be able to make suitable modifications or changes based on the specification disclosed below without breaching the spirit of the invention. Designations common to the accompanying drawings are used to indicate identical or similar elements.

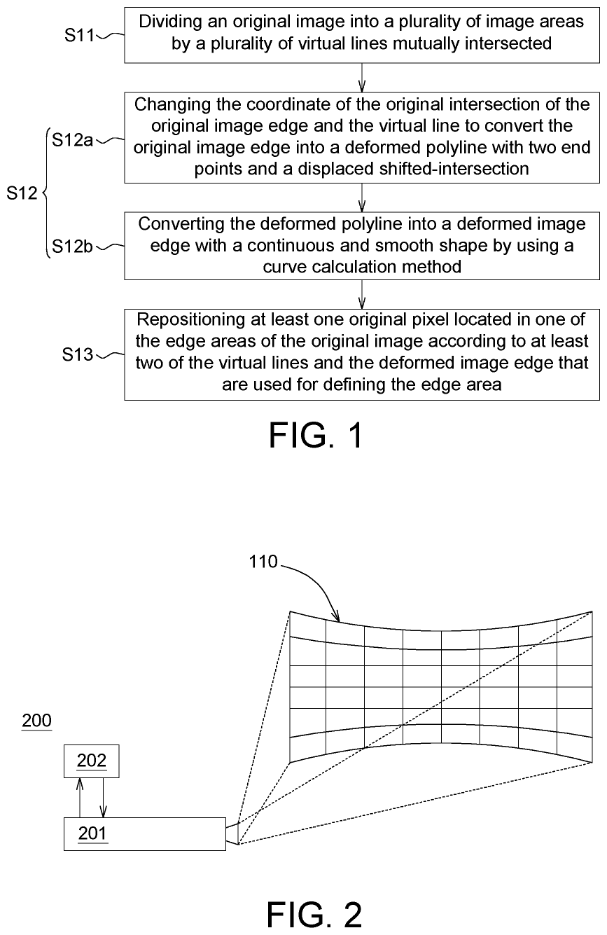

Referring to FIG. 1, a flowchart of an image adjusting method according to an embodiment of the present disclosure is shown. In some embodiments of the present disclosure, the image adjusting method of FIG. 1 can be used in different display devices, such as one of liquid crystal display (LCD), LCD with curved screen, electronic paper display (EPD) or electronic ink (E-Ink) display panel, or can be used in any image projection devices, such as a projector that can perform non-linear projection on any curved screen.

Referring to FIG. 2, a block diagram of a projector image adjusting system 200 applicable to the said image adjusting method according to an embodiment of the present disclosure is shown. The projector image adjusting system 200 includes a projection device 201 and a user interface 202. In some embodiments of the present disclosure, the projection device 201 can be realized by a digital light processor (DLP) projector, a liquid crystal display (LCD) projector, or a laser projector. The user interface 202 is electrically connected the projection device 201 and can be realized by a computer, an appliance, a machine, a mobile communication device, a software, or a design of application program and website for implementing the image adjusting method of FIG. 1 under the guidance of the user's experience and interaction.

In some embodiments of the present disclosure, examples of the user interface 202 include (but are not limited to) at least one system on chip (SOC), field programmable gate array (FPGA) chip, complex programmable logic device (CPLD), microprocessor, central processing unit (CPU), other hardware, software, or firmware element with computation ability, or a combination thereof (not illustrated).

The image adjusting method of FIG. 1 includes the following steps. Firstly, an original image 100 is projected by the projection device 201 as shown in FIG. 2. Then, a plurality of mutually intersecting virtual lines 101a-101e are provided by the user interface 202 for dividing the original image 100 into a plurality of image areas 102 (as indicated in step S11 of FIG. 1).

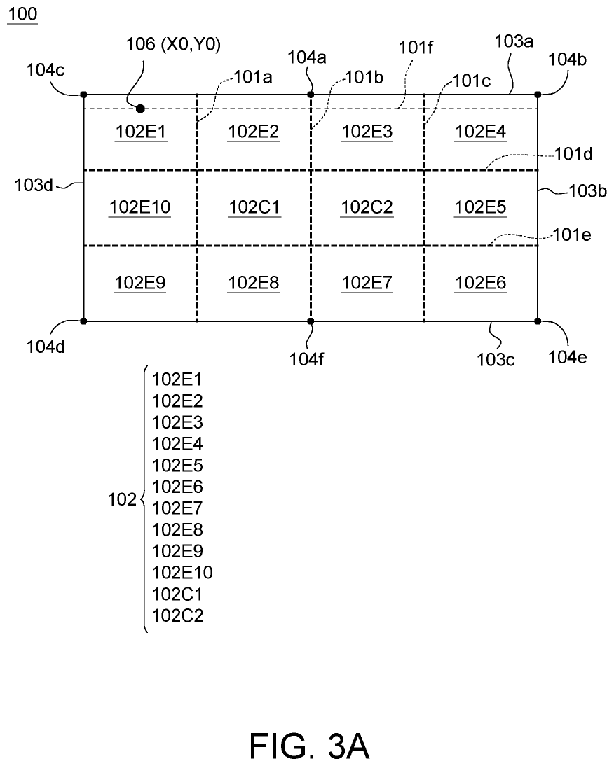

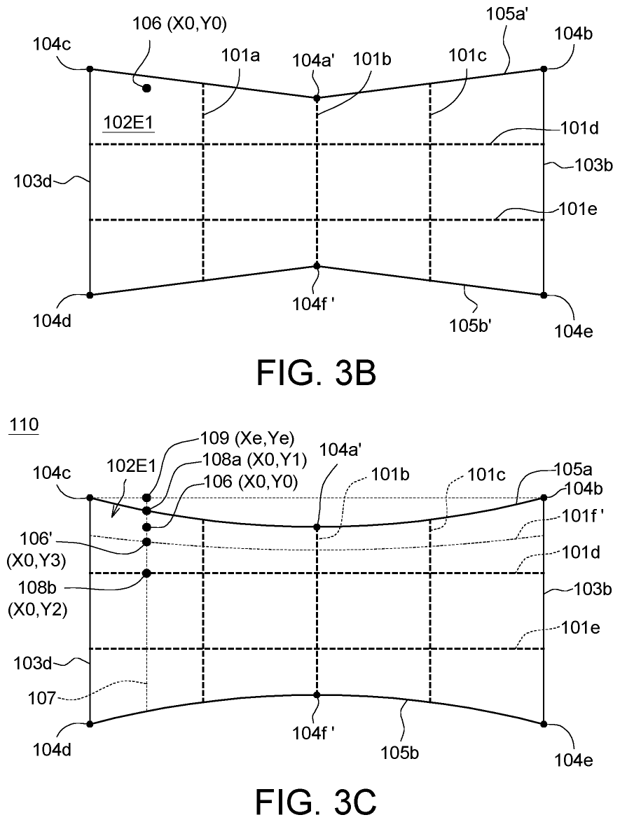

Refer to FIG. 3A to FIG. 3C. FIG. 3A is a schematic frame of an original image 100 according to an embodiment of the present disclosure. FIG. 3B to FIG. 3C are schematic frames of image adjustment of the original image 100 of FIG. 3A according to an embodiment of the present disclosure. In some embodiments of the present disclosure, the original image 100 can be a polygonal image (e.g., including but not limited to a rectangular image or a triangular image, a quadrilateral image, or a pentagonal image with regular or irregular sides), a circular image, an elliptical image or an image with an arced side or an image with other shapes.

In the present embodiment, the original image 100 is a rectangular image with a plurality of original image edges 103a-103d. The image areas 102 include a plurality of edge areas 102E1-102E10 and a plurality of center areas 102C1 and 102C2. Each edge area (one of the edge areas 102E1-102E10) is defined by at least one original image edge of the original image 100 (one of the original image edges 103a-103d) and at least two virtual lines (two of the virtual lines 101a-101e). Taking the edge area 102 E1 as an example, the edge area 102 E1 is a checkered area defined by two original image edges 103a and 103d of the original image 100 and two virtual lines 101a and 101d.

Then, the coordinate of at least one intersection of at least one virtual line and the original image edge (such as the intersection 104a of the virtual line 101b and the original image edge 103a) can be changed to obtain a deformed image edge 105a (as indicated in step S12 of FIG. 1).

In the present embodiment, obtaining the deformed image edge 105a may include steps as follows: is used, At least one original intersection (such as original intersection 104a) of the original image edge 103a of the original image 100 and at least one virtual line (such as virtual line 101b) is selected, and the original intersection 104a is dragged down to the intersection 104a′ by using a user interface 202, such that the original image edge 103a can be converted to a deformed polyline 105a′ with two endpoints 104b and 104c and a shifted-intersection 104a′. Meanwhile, a similar step can be performed to move the original intersection 104f of the original image edge 103c and the virtual line 101b, such that the original image edge 103c can be converted to a deformed polyline 105b′ with two endpoints 104d and 104e and a shifted-intersection 104f′ (referring to step S12a of FIG. 1 and FIG. 3B).

As indicated in step S12b of FIG. 1: the deformed polyline 105a′ is converted into a deformed image edge 105a with a continuous and smooth shape by using a curve calculation method (such as Bézier curve method) according to the two end points 104b and 104c of the original image edge 103a and the shifted-intersection 104a′. Meanwhile, a similar step is performed, the deformed polyline 105b′ is converted to a deformed image edge 105b with a continuous and smooth shape (as indicated in FIG. 3C).

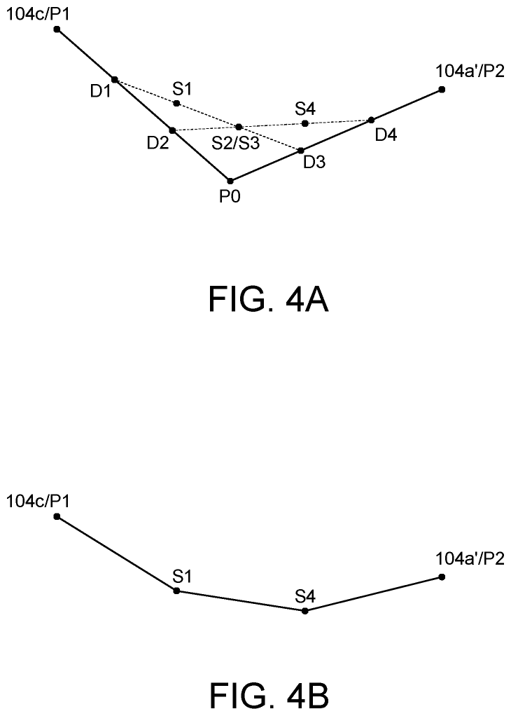

Refer to FIG. 4A and FIG. 4B. FIG. 4A to and FIG. 4B are schematic diagrams of a part of curve conversion step of converting a deformed polyline 105a′ into a deformed image edge 105a with a continuous and smooth shape according to an embodiment of the present disclosure. For the convenience of illustration, FIG. 4A and FIG. 4B only illustrate the step of converting a part of the deformed polyline 105a′ (such as the straight line segment between the end point 104c and the intersection 104a′ of the deformed polyline 105a′ as shown in FIG. 3B) into a curve (such as curve segment between the end point 104c and the intersection 104a′ of the deformed image edge 105a as shown in FIG. 3C).

Firstly, as indicated in FIG. 4A, a dummy point P0 is selected between the end point 104c and the intersection 104a′ in the bending direction of the curve, wherein the end point 104c is represented by P1 and the intersection 104a′ is represented by P2, and the dummy point P0 satisfies the following relationship: Nodes D1 and D2 divide the segment P1P0 connecting the dummy point P0 and the end point 104c into three equal parts; and segment P1D1=segment D1D2=segment D2P0; nodes D3 and D4 divide the segment P2P0 connecting the dummy point P0 and the intersection 104a′ into three equal parts; and segment P2D4=segment D4D3=segment D3P0. Nodes D1 and D3 are connected and so are nodes D2 and D4, such that the segment D1D3 intersects the segment D2D4. Then, nodes S1 and S2 are provided to divide segment D1D3 into three equal parts, such that segment D1S1=segment S1S2=segment D3S2. Similarly, nodes S3 and S4 are provided to divide segment D2D4 into three equal parts, such that segment D2S3=segment S3S4=segment D4S4.

Two relay points can be selected from the segment D1D3 and the segment D2D4 that are respectively disposed on two opposite sides of the intersection of the segment D1D3 and the segment D2D4. In the present embodiment, the intersection of the segment D1D3 and the segment D2D4 is the overlapping node S2/S3. These two relay points selected from the segment D1D3 and the segment D2D4 respectively disposed on the two opposite sides of the intersection S2/S3 can be the nodes S1 and S4. By connecting the end point 104c (P1), the intersection 104a′ (P2) and the two relay points (node S1 and S4), a polyline composed of three segments P1S1, S1S4 and S4P2 can be obtained (as shown in FIG. 4B). The above step can be repeated until the deformed polyline 105b′ is converted into a deformed image edge 105b with a continuous and smooth shape.

Subsequently, at least one original pixel (such as original pixel 106) located in the at least one edge area (such as the edge area 102E1) is repositioned (as indicated in step S13 of FIG. 1) according to the at least two of the virtual lines (such as the virtual lines 101a and 101d), used for defining the at least one edge area (such as edge area 102E1), and the deformed image edge (such as the deformed image edge 105a). For the purpose of clarifying the repositioning process more concisely, merely the reposition of one single original pixel 106 located in the edge area 102E1 is described as below.

In the present embodiment, the repositioning process of the original pixel 106 includes the following steps. A straight line 107passing through the original plane coordinate (X0, Y0) of the original pixel 106 and parallel to a coordinate axis (such as Y axis) is drawn to intersect one of the virtual lines defining the edge area 102E1 (e.g., the virtual line 101d) and the deformed image edge 105a to obtain the coordinate (X0, Y1) and (X0, Y2) of the intersections 108a and 108b respectively (referring to step 513a of FIG. 1 and FIG. 3C).

Then, the coordinate (X0, Y3) of a repositioned position of the repositioned pixel 106′ can be calculated by using an interpolation method according to the relative relationships among two intersections 109 and 108b as well as the original pixel 106. Wherein these two intersections 109 and 108b are respectively defined by the straight line 107 and the original image edge 103a as well by the straight line 107 and the virtual line 101d. In detailed, when the original image edge 103a is converted to a deformed image edge 105a, a virtual line 101f that is originally parallel to the original image edge 103a and passing through the original pixels 106 can be adjusted (proportionally) in the same direction with the deformed image edge 105a and converted to a curve 101f′. The repositioned pixel 106′ is located at an intersection of the straight line 107 and the virtual line 101f′, and the coordinate (X0, Y3) of the repositioned pixel 106′ can be calculated by using an interpolation method. Thereby the original pixel 106 can be repositioned to the repositioned position 106′ (referring to step S13a of FIG. 1). Meanwhile, similar steps can be performed to reposition other original pixels (not illustrated) in each of the edge area 102E1-102E10 in the original image 100 to obtain the deformed image 110 as shown in FIG. 3C.

It should be noted that in the step of obtaining the deformed image edge 105a to convert the deformed polyline 105a′ into a deformed image edge 105a with a continuous and smooth shape, the step S12b of FIG. 1 is not compulsory. Therefore, in some other embodiments of the present disclosure, the deformed image edge obtained by the method with omitting the step S12b of FIG. 1 can be a continuous polyline (that is, the deformed polyline 105a′) connecting two end points of the original image edge 104b and 104c and the intersection 104a′. In other words, the deformed image (not illustrated) obtained by the method with omitting the step S12b of FIG. 1 can be a polygonal image.

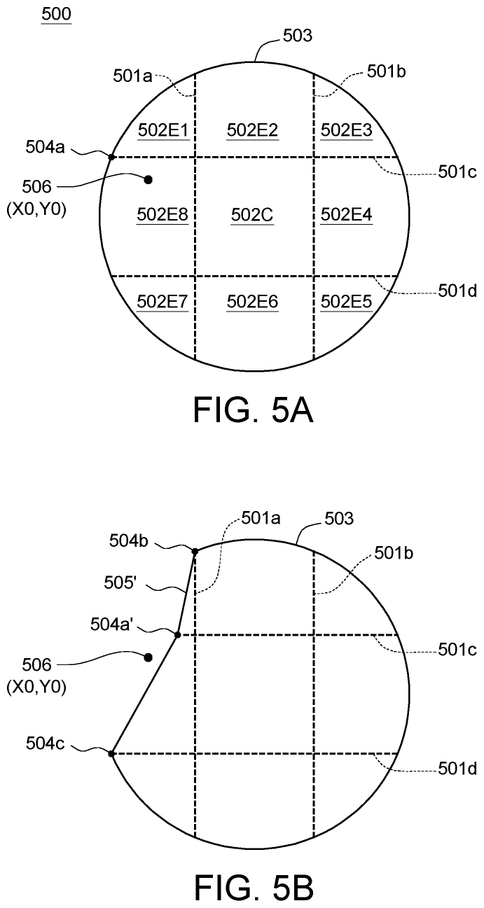

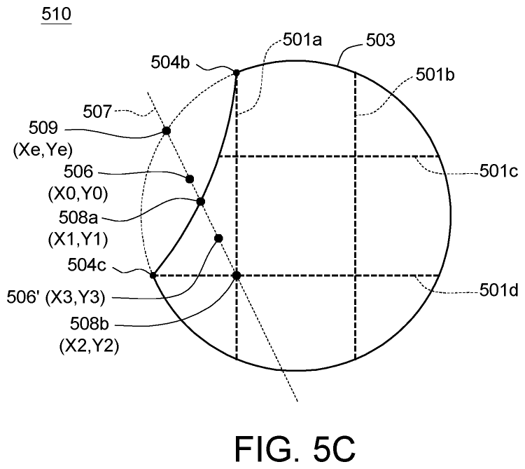

Refer to FIG. 5A to FIG. 5C. FIG. 5A is a schematic frame of an original image 500 according to another embodiment of the present disclosure. FIG. 5B to FIG. 5C are schematic frames of image adjustment of the original image 500 of FIG. 5A according to another embodiment of the present disclosure. The original image 500 is a circular image, an original image edge 503 with a single circle. The image adjusting method of the original image 500 includes the following steps:

Firstly, the original image 500 is divided into a plurality of image areas 502 by a plurality of mutually intersecting virtual lines 501a-501d. The image areas 102 include a plurality of edge areas 502E1-502E8 and a center area 502C. Each edge area (one of the edge areas 502E1-502E8) can be defined by the original image edge (such as the original image edge 503) of the original image 500 and three virtual lines (such as three of the virtual lines 501a-501d). Taking the edge area 502 E1 as an example, the edge area 502 E1 is an area defined by the original image edge 503 of the original image 500 and the virtual lines 501a and 501c.

Then, a deformed image edge 505 can be obtained by changing the coordinate of at least one intersection (such as original intersection 504a) of at least one virtual line (such as the virtual lines 501c) and the original image edge 503. In the present embodiment, the process of obtaining the deformed image edge 505 may include steps as follows: the original intersection 504a of the original image edge 503 and the virtual line 501c is selected, then the user interface 202 is used to drag the original intersection 504a towards the center of the circular original image 500 to a shifted-intersection 504a′, such that the circular original image edge 503 becomes a deformed polyline 505′ recessed towards the center of the circle. The deformed polyline 505′ includes the shifted-intersection 504a′ and two original intersections 504b and 504c (as shown n FIG. 5B) adjacent to the shifted-intersection 504a′.

Then, the deformed polyline 505′ is converted into a deformed image edge 505 with a continuous and smooth shape (as shown in FIG. 5C) by using a Bézier curve method or the method as shown in FIG. 4A and FIG. 4B according to the shifted-intersection 504a′ of the deformed polyline 505′ and two original intersections 504b and 504c. The calculation of converting a polyline into a smooth curve is already disclosed above and is not repeated here.

Subsequently, at least one original pixel 506 located in at least one edge area (such as edge area 502E8) is repositioned according to at least two virtual lines (such as the virtual lines 501a and 501d), used for defining at least one edge area (such as the edge area 502E8), and the deformed image edge 505. For the purpose of clarifying the repositioning process more concisely, merely the reposition of one single original pixel 506 located in the edge area 502E8 is described as below.

In the present embodiment, the repositioning process of the original pixel 506 includes the following steps: a straight line 507 that passes through the original plane coordinate (X0, Y0) of the original pixel 506 and passes through the intersection 508b of two virtual lines 501a and 501d used for defining the edge area 502E1, is drawn in FIG. 5C to intersect the deformed image edge 505 at the intersection 508a; and the coordinate (X1, Y1) and (X2, Y2) of the intersections 508a and 508b are respectively obtained.

Then, the coordinate (X3, Y3) of a repositioned position of the repositioned pixel 506′ can be calculated by using an interpolation method according to the relative relationships among the coordinate (Xe, Ye) of the intersection 509, the coordinate (X2, Y2) of intersection 508b the original plane coordinate (X0, Y0) of the original pixel 506. Wherein the intersection 509 is defined by the original image edge 503 and the straight line 507. In detail, when the original image edge 503 is converted into a deformed image edge 505 and the coordinate (Xe, Ye) of the intersection 509is moved to the coordinate (X1, Y1) of the intersection 508a,coordinate (X3, Y3) the original plane coordinate (X0, Y0) of the original pixel 506 can be (proportionally) moved in the same direction, and the coordinate (X3, Y3) of the repositioned pixel 506′ can be calculated by using an interpolation method the original pixel 106 the106′ (referring to step S13a of FIG. 1). and Thereby, the original plane coordinate (X0, Y0) of the original pixel 506 can be repositioned to the coordinate (X3, Y3) of the repositioned original pixel 506. Meanwhile, similar steps can be performed to reposition other original pixels (not illustrated) in the edge area 502E1 of the original image 500 to obtain the deformed image 510 as shown in FIG. 5C.

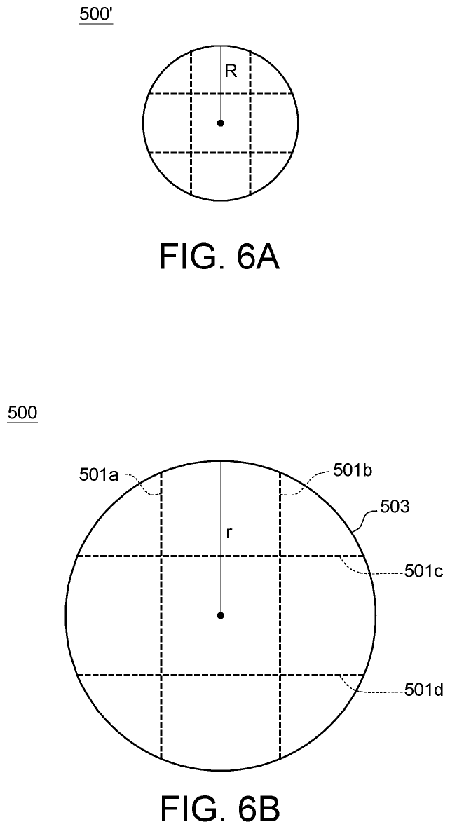

In the present embodiment, before the deformed image edge 505 is obtained, the size of the circular original image 500 can be adjusted according to a radius proportion. Refer to FIG. 6A and FIG. 6B, schematic frames of proportionally scaling of the original image 500 according to an alternate embodiment of the present disclosure. In the present embodiment, a circular original image 500′ with a radius R (as shown in FIG. 6A) can be adjusted proportionally as a circular original image 500 with a radius r (as shown in FIG. 6B). Then, the image adjustment steps as shown in FIG. 5A to FIG. 5C can be performed subsequently.

As disclosed above, the embodiments of the present disclosure provide an image adjusting method and applications thereof. An original image is divided into a plurality of image areas by a plurality of virtual lines to provide the user with a number of selection points which are define by the virtual lines intersecting with the original image edge of the original image. The user can change the coordinate of the selected point to obtain a deformed image edge by using a specific algorithm (such as interpolation). Then, at least one original pixel located in the edge area of the original image can be repositioned according to the deformed image edge for converting the original image into an adjusted image. In other words, by changing the displaying position of the selected point at the image edge of the original image through a user interface, the user can easily adjust the shape of the original image to generate an adjusted image (deformed image) meeting the requirements.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image adjusting method, comprising:
dividing an original image into a plurality of image areas by a plurality of virtual lines mutually intersected, wherein the plurality of image areas comprise a plurality of edge areas each being defined by at least one original image edge of the original image and at least two of the plurality of virtual lines;
changing the coordinate of at least one intersection of at least one of the plurality of virtual lines and the original image edge to obtain a deformed image edge; and
repositioning at least one original pixel located in one of the plurality of edge areas of the original image according to the at least two of the virtual lines and the deformed image edge.

2. The image adjusting method according to claim 1, wherein the original image is a polygonal image with a plurality of original image edges.

3. The image adjusting method according to claim 1, wherein the deformed image edge is a continuous and smooth shape curve formed by using a Bézier curve method and comprising two end points of the original image edge and the at least one intersection.

4. The image adjusting method according to claim 3, wherein the step of repositioning the at least one original pixel comprises:
drawing a straight line passing through an original plane coordinate of the original pixel, parallel to a coordinate axis and intersecting one of the at least two of the virtual lines and the deformed image edge to obtain a coordinate of a first intersection and a coordinate of a second intersection; and
obtaining a pixel adjustment coordinate by using an interpolation method according to the coordinate of the first intersection and the coordinate of the second intersection.

5. The image adjusting method according to claim 1, wherein the original image is a circular image, and the at least one original image edge shapes as a circle.

6. The image adjusting method according to claim 5, wherein the step of repositioning the at least one original pixel comprises:
drawing a straight line passing through an original plane coordinate of the original pixel and an intersection of the at least two of the virtual lines and intersecting the deformed image edge to obtain a coordinate of a first intersection and a coordinate of a second intersection; and
obtaining a pixel adjustment coordinate by using an interpolation method according to the coordinate of the first intersection and the coordinate of the second intersection.

7. The image adjusting method according to claim 5, before obtaining the deformed image edge, further comprising adjusting the size of the circular image according to a radius proportion.

8. The image adjusting method according to claim 1, wherein the deformed image edge is a continuous polyline connecting two end points of the original image edge and the at least one intersection.

9. An image adjusting system, comprising:
a user interface (UI) configured to perform an image adjusting method comprising:
dividing an original image into a plurality of image areas by a plurality of virtual lines mutually intersected, wherein the plurality of image areas comprise a plurality of edge areas each being defined by at least one original image edge of the original image and at least two of the plurality of virtual lines;
changing the coordinate of at least one intersection of at least one of the plurality of virtual lines and the original image edge to obtain a deformed image edge; and
repositioning at least one original pixel located in one of the plurality of edge areas of the original image according to the at least two of the virtual lines and the deformed image edge.

10. An projector image adjusting system, comprising:
a user interface, configured to:
provide a plurality of virtual lines mutually intersected for dividing an original image into a plurality of image areas, wherein the plurality of image areas comprise a plurality of edge areas, each being defined by at least one original image edge of the original image and at least two of the virtual lines;
change the coordinate of at least one intersection of at least one of the plurality of virtual lines and the original image edge to obtain a deformed image edge; and
reposition at least one original pixel located in one of the plurality of edge areas of the original image according to the at least two of the virtual lines and the deformed image edge to convert the original image into an adjusted image; and
a projection device configured to project the original image and the adjusted image.

11. The image adjusting method of a projector according to claim 10, wherein the original image is a polygonal image with a plurality of original image edges.

12. The projector image adjusting system according to claim 10, wherein the deformed image edge is a continuous and smooth shape curve formed by using an interpolation method and comprising two end points of the original image edge and the at least one intersection.

13. The projector image adjusting system according to claim 12, wherein the step of repositioning the at least one original pixel comprises:
drawing a straight line passing through an original plane coordinate of the original pixel, parallel to a coordinate axis and intersecting one of the at least two of the virtual lines and the deformed image edge to obtain a coordinate of a first intersection and a coordinate of a second intersection; and
obtaining a pixel adjustment coordinate by using an interpolation method according to the coordinate of the first intersection and the coordinate of the second intersection.

14. The projector image adjusting system according to claim 10, wherein the original image is a circular image, and the at least one original image edge shapes as a circle.

15. The image adjusting method of a projector according to claim 14, wherein the step of repositioning the at least one original pixel comprises:
drawing a straight line passing through an original plane coordinate of the original pixel and an intersection of the at least two of the virtual lines and intersecting the deformed image edge to obtain a coordinate of a first intersection and a coordinate of a second intersection; and
obtaining a pixel adjustment coordinate by using an interpolation method according to the coordinate of the first intersection and the coordinate of the second intersection.

16. The projector image adjusting system according to claim 14, before obtaining the deformed image edge, further comprising adjusting the size of the circular image according to a radius proportion.

17. The projector image adjusting system according to claim 10, wherein the deformed image edge is a continuous polyline connecting two end points of the original image edge and the at least one intersection.
